(19) United States
(12) Patent Application Publication
(10) Pub. No.: US 2009/0144797 A1
(43) Pub. Date: Jun. 4, 2009

(54) Method and Apparatus for Delivering SDV Programming With Multiple Advertisements

(75) Inventors: Yeqing Wang, Horsham, PA (US); Patrick J. Leary, Horsham, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/948,141

(22) Filed: Nov. 30, 2007

(51) Int. Cl. H04N 7/173

(52) U.S. Cl. 725/131

(57) ABSTRACT

A set top terminal is provided that includes a receiver/tuner for receiving (i) switched digital video (SDV) programs over a broadband access network, at least one of the SDV programs including a primary advertisement and (ii) a plurality of alternative advertisements that are each substitutable for the primary advertisement. The set top terminal also includes a processor operationally associated with the receiver/tuner. The processor is configured to selectively cause a first of the alternative advertisements to be rendered instead of the primary advertisement when the first alternative advertisement better matches a prescribed condition than the primary advertisement.

### FIELD OF THE INVENTION

The present invention relates generally to a switched digital video system for distributing content to a subscriber over a system such as a satellite or cable television system, and more particularly to a switched digital video system in which advertising can be targeted to subscribers by selecting one from a plurality of advertisements.

### BACKGROUND OF THE INVENTION

Switched digital video (SDV) refers to an arrangement in which broadcast channels are only switched onto the network when they are requested by one or more subscribers, thereby allowing system operators to save bandwidth over their distribution network. In conventional cable or satellite broadcast systems, every broadcast channel is always available to all authorized subscribers. In contrast, a switched digital video channel is only available when requested by one or more authorized subscribers. Also, unlike video on-demand, which switches a singlecast interactive program to a user, switched digital video switches broadcast streams, making each stream available to one or more subscribers who simply join the broadcast stream just as they would with normal broadcast services. That is, once a switched service is streamed to a subscriber, subsequent subscribers associated with the same service group as the first subscriber can tune to the same broadcast stream. The switched digital video will often share the same resource managers and underlying resources with other on-demand services.

As noted, switched digital video is largely a tool to save bandwidth. From the subscriber perspective, he or she still receives the same broadcast video service when using a switched broadcast technique; ideally the user is not able to discern that the stream was switched at all. If each one of the digital broadcast channels is being watched by subscribers in the same service group, the switched digital video approach does not yield any bandwidth savings. However, a more likely situation statistically is that only a certain number of the digital broadcast channels are being watched by subscribers in the same service group at any given time. Those channels not requested by a subscriber need not be broadcast, thereby saving bandwidth.

One way to support switched digital video is to utilize a session manager to manage SDV sessions and provision services. The subscriber's receiver (e.g., a set-top terminal) will request an SDV program from the session manager. The session manager will determine if the requested channel is already being sent to the corresponding service group that the subscriber belongs to. The subscriber receiver will be assigned to join the existing SDV service if the requested channel is available at the service group or assigned to a new SDV service if the requested channel is not available at the service group. The Session Manager will negotiate with the edge devices to allocate resources required for the service. The edge device (e.g., a digital modulator such as a QAM modulator) needs to dynamically retrieve the MPEG single program transport stream that carries the requested broadcast program (likely via IP unicast or multicast) and generate the MPEG multiple program transport stream. As part of the service setup response message, the video tuning parameters such as frequency and MPEG program number are sent back to the subscriber to access the requested broadcast channel.

As with other types of broadcast programming, advertising forms an important part of SDV programming. The revenues generated from advertisers subsidize and in some cases pay entirely for the programming. Even in subscriber-based television systems such as cable and satellite television systems, the revenues from advertisements subsidize the cost of the programming, and were it not for advertisements, the monthly subscription rates in such systems could be many times higher than at present.

Traditional broadcast television systems broadcast the same television signal to each person viewing a particular station. Thus, each person viewing a particular channel will necessarily view the same programming content as well as the same advertisements embedded in the programming content. However, with modern digital television systems such as SDV systems more personalized television service is possible. For instance, in SDV systems, a group of subscriber households can be selectively addressed through a cable node serving that group. Similarly, individual subscriber households can be selectively addressed though their set top terminals. In other words, the service provider can send different data to different subscribers or groups of subscribers.

Typically, a particular advertiser will purchase a particular “spot”, i.e., an advertising opportunity in a particular channel at a particular time, based on the likelihood that members of that advertiser's target audience will be watching that particular channel at that particular time. For instance, advertisers typically have a particular demographic group of individuals that they wish to reach with their advertising. For example, the manufacturer of a low-cost beer probably has a primary target audience of males between the ages of 21 and 39, living in households with a household annual income of less than $75,000 per year. As another example, a manufacturer of laundry detergent may have a primary target audience of women between 19-59 years of age with no particular preference regarding household income. In yet another example, a manufacturer of expensive beer may wish to have a target audience similar to that of the manufacturer of low-cost beer in that it comprises males between the ages of 21 and 39. However, this manufacturer's target demographic audience may include a different economic profile, e.g., males between the ages of 21 and 39, living in households with annual household incomes of over $60,000 per year. Another advertiser that manufactures children's toys appropriate for children between 5 and 10 years of age might have a target audience of children between the ages of 5 and 10 and, depending upon the particular toys, a desired annual household income range.

The selective addressability of modern digital television service systems renders more targeted TV advertising possible. As a result, demographic data may be used to provide different subscribers of the same television program different advertisements that are particularly directed to them. In order to effectively target advertising to subscribers it is necessary to understand certain attributes of the target subscriber, such as demographic and psychograph attributes, and to acquire any data relevant to determining the appropriateness of an advertisement for the particular subscriber. Such data can include past viewing habits and previous purchasing selections and the like.

While advertising may be delivered using demographic data concerning target subscribers, the actual subscribers viewing a particular program at any given time is continually changing, which complicates the process of selecting advertisements for targeted advertising. In addition, once the appropriate advertisements have been selected, a mechanism is needed to properly deliver them to the appropriate subscribers without overtaxing network resources. For instance, if the advertisements are too finely targeted among the subscribers, the total bandwidth that is needed to send all the advertisements could exceed the bandwidth that is available.

Accordingly, it would be desirable to deliver advertising to subscribers in a targeted manner that takes into account real-time fluctuations in both viewership and network resource availability.

### BRIEF DESCRIPTION OF THE DRAWINGS

FIG. 1 shows one example of a system architecture for delivering switched digital video content to a subscriber.

FIG. 2 shows one example of a headend that can be used to deliver SDV programming to target groups of subscribers.

FIG. 3a illustrates the headend transmitting the primary advertisement and the alternative advertisements in the same transport stream and FIG. 3b illustrates the headend transmitting the primary advertisement and the alternative advertisements in separate transport streams.

FIG. 4 is a flowchart showing one example of a method for selecting alternative advertisements that are to be provided to a subscriber.

FIG. 5 shows one example of a set top terminal.

FIG. 6 is flowchart showing one example of a method for providing SDV programming with primary advertisements and alternative advertisements to subscribers.

### DETAILED DESCRIPTION

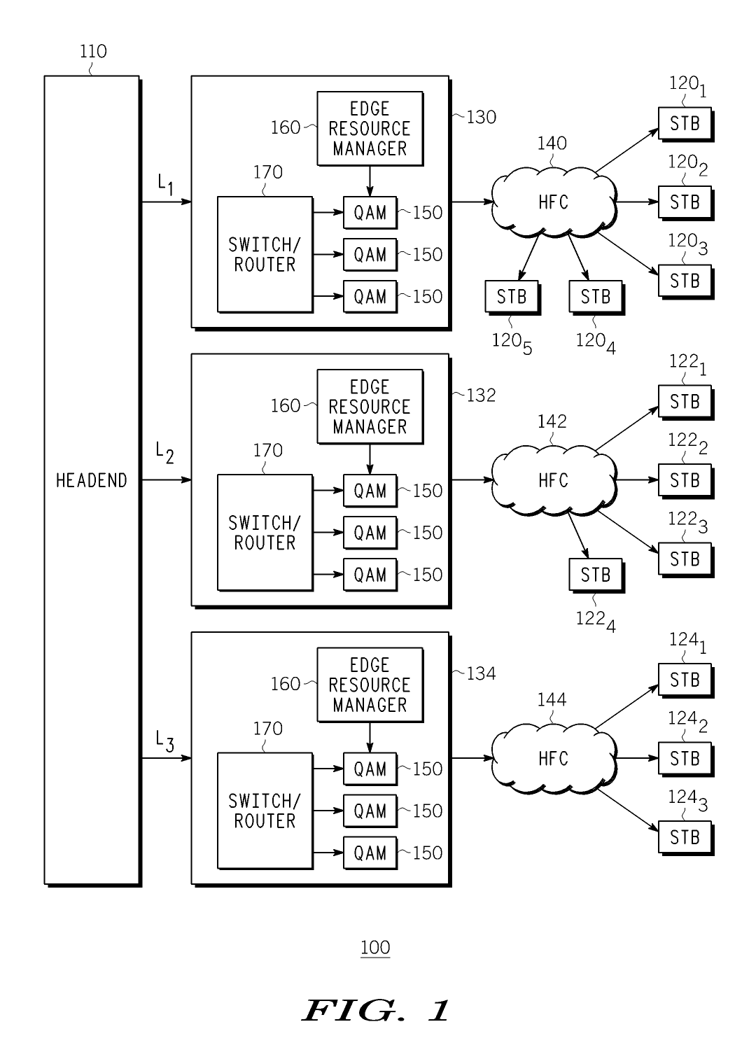

FIG. 1 is a system architecture 100 for delivering switched digital channels to a subscriber during a switched digital video (SDV) session. The SDV session is implemented through a service offering in which application level data generated by a set-top terminal initiates a SDV session request and an SDV manager routes data in accordance with the request to provision the service. Among other components, system architecture 100 comprises a content source such as a headend 110 that is connected to multiple intermediate entities such as hubs 130, 132 and 134. The headend 110 communicates with a switch or router 170 in hubs 130, 132 and 134 over links L1, L2 and L3, respectively. The headend 110 and hubs 130, 132 and 134 may communicate over a packet-switched network such as a cable data network, passive optical network (PON) or the like using, for example, IP multicast or unicast addressing. Details concerning multicast and unicast addressing as they pertain to targeted advertising will be presented below. As used herein, advertising refers to any content that interrupts the primary content that is of interest to the viewer. Accordingly, advertising can include but is not limited to, content supplied by a sponsor, the service provider, or any other party, which is intended to inform the viewer about a product or service. For instance, public service announcements, station identifiers and the like are also referred to as advertising.

Some or even all of the hubs are connected to multiple users, typically via distribution networks such as local cable access networks (e.g., HFC networks). For simplicity of explanation only, each hub is shown as being connected to a distinct HFC network, which in turn communicates with end user equipment as illustrated. In particular hubs 130, 132 and 134 in FIG. 1 communicate with access networks 140, 142 and 144, respectively. Each access network 140, 142 and 144 in turn communicates with multiple end user devices such as set top terminals. In the example of FIG. 1, access network 140 communicates with set top terminals 120₁, 120₂, 120₃, 120₄ and 120₅, access network 142 communicates with set top terminals 122₁, 122₂, 122₃ and 124₄, and access network 144 communicates with set top terminals 124₁, 124₂ and 124₃.

In addition to the switch or router 170, each hub can include an array of radio frequency transmitter edge devices such as edge QAM modulators 150. The number of edge devices 150 in each hub may vary as needs dictate. As used herein, the term “QAM” refers to modulation schemes used for sending signals over cable access networks. Such modulation schemes might use any constellation level (e.g. QAM-16, QAM-64, QAM-256 etc.) depending on the details of a cable access network. A QAM may also refer to a physical channel modulated according to such schemes. Typically, a single QAM modulator can output a multiplex of ten or twelve programs, although the actual number will be dictated by a number of factors, including the communication standard that is employed. The edge QAM modulators usually are adapted to: (i) receive Ethernet frames that encapsulate the transport packets, (ii) de-capsulate these frames and remove network jitter, and (iii) transmit radio frequency signals representative of the transport stream packets to end users, over the HFC network. Each transport stream is mapped to a downstream QAM channel. Each QAM channel has a carrier frequency that differs from the carrier frequency of the other channels. The transport streams are mapped according to a channel plan designed by a system operator that operates the network.

Each hub 130, 132 and 134 also includes an edge resource manager 160 for allocating and managing the resources of the edge devices 150. The edge resource manager 160 communicates with and receives instructions from the session manager located in the headend 110.

When a viewer selects an SDV channel using a subscriber terminal such as a set top terminal, the SDV system actively switches the channel onto one of the QAMs that serves that particular set top terminal. The set top terminals are generally arranged into service groups and each of the service groups is assigned to, and serviced by, one or more QAM modulators. For example, in the arrangement depicted in FIG. 1 set top terminals 120₁, 120₂, 120₃, 120₄ and 120₅ are assigned to QAM modulators 150 located at hub 130, set top terminals 122₁, 122₂, 122₃ and 122₄ are assigned to QAM modulators 150 located at hub 132, and set top terminals 124₁, 124₂ and 124₃ are assigned to QAM modulators 150 located at hub 134. Typically, four (4) or eight (8) QAM modulators are deployed per service group to carry the SDV channels. SDV service groups currently include from about 500 to 1000 set top terminals. Depending on the system topology, there may or may not be a one-to-one correspondence between the hubs and the service groups. For instance, it is typically the case that each hub serves multiple service groups.

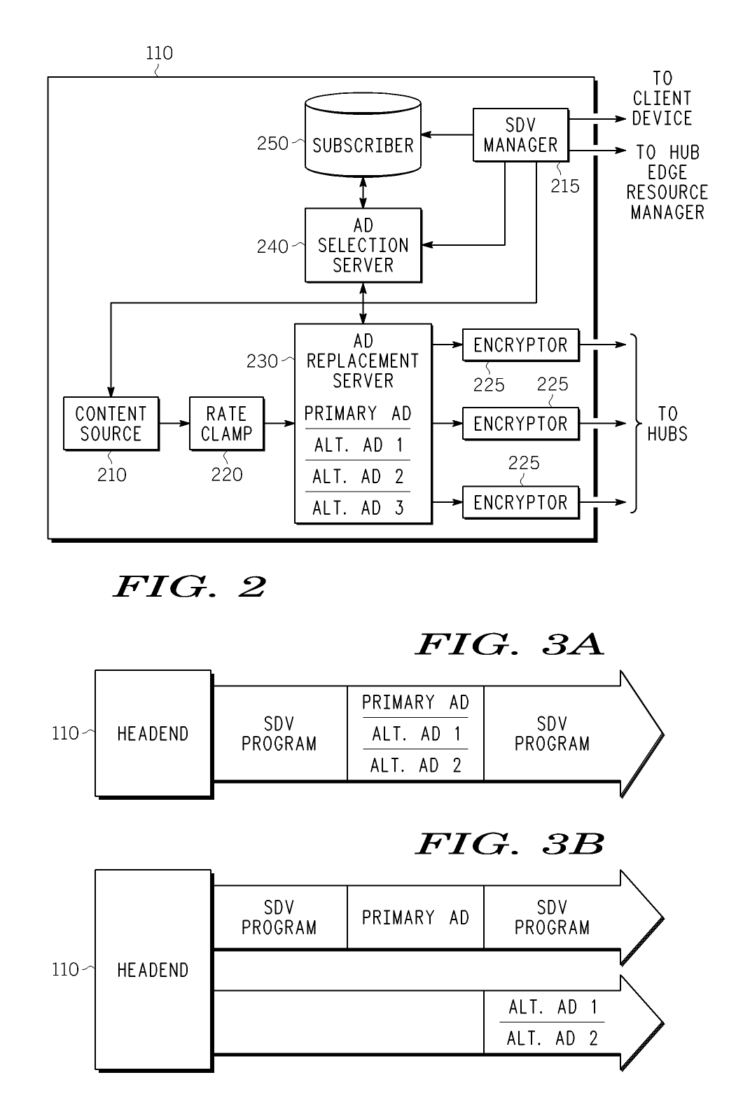

FIG. 2 shows one example of headend 110. The headend 110 includes a broadcast content source 210, which may include, by way of example, satellite receivers, off-air receivers and/or content storage devices such as servers. An SDV manager 215 is used to determine which SDV transport streams are being transmitted by the headend at any time and for directing the set top terminals to the appropriate stream. The SDV manager 215 also keeps track of which subscribers are watching which channels and it communicates with the edge resource managers 160 (see FIG. 1) in the hubs so that the content can be switched on and off under the control of the SDV manager 215. In addition, all subscriber requests for a switched digital channel go through the SDV manager 215. Content is forwarded by the content source to a rate clamp 220, an ad replacement server 230 that inserts the appropriate advertisements into their respective timeslots, and one or more optional encryptors 225. In this example the content is then encrypted in this example by the encryptors 225 and transmitted to the appropriate hub or hubs using, in this example, multicast addressing. Typically, standard definition (SD) channels are currently rate clamped to 3.75 Mbps while high definition channels are currently rate clamped to between about 12 Mbps and 15 Mbps. The encryptors 225 encrypt the digitally encoded content, often under the control of a conditional access system (not shown). As discussed in more detail below, the ad replacement server 230 inserts the advertisements under the direction of an ad selection server 240, which in turn makes its determinations based on information received from the SDV manager 215 and a subscriber demographics database 250.

It should be noted that the headend 110 shown in FIG. 2 may also include a variety of other components for offering additional services. For example, the head-end 110 may comprise typical head-end components and services including a billing module, a video-on-demand (VOD) server, a subscriber management system (SMS) or billing module, a conditional access system and a LAN(s) for placing the various components in data communication with one another. Also, although not shown, one of ordinary skill in the art would recognize that other components and arrangements for achieving the various functionalities of headend 110 are possible. It will also be appreciated that the head-end configurations depicted in FIG. 2 is a high-level, conceptual architecture and that each system may have multiple head-ends deployed using different architectures.

Enhanced targeting of advertisements to subscribers can be accomplished by presenting the subscriber's set top terminal with multiple advertisements from which to choose. The choice of which of the advertisements to present to the subscriber at any given time may be made by the set top terminal itself or by the service provider (e.g., an MSO) through the SDV manager. Returning to the headend shown in FIG. 2, in one example this enhanced advertising feature can be implemented with use of the ad replacement server 230, ad selection server 240 and the subscriber demographics database 250.

The subscriber demographics database 250 stores demographic data that can be used to select advertisements most appropriate to individual or groups of subscribers. The demographic data located in the database 250 can be acquired in any of a variety of different ways. For example, subscriber viewing history, subscriber geography, purchased (e.g., third party psychographic and demographic) data, and subscriber self-reporting in response to questionnaires and the like may all be used to populate the subscriber demographic database 250. The ad replacement server 230 is pre-loaded with candidate advertisements that can be inserted at the appropriate points in the programming. Multiple advertisements may be available for each advertising timeslot in the programming. The ad selection server 240 chooses the most appropriate advertisement to be inserted into each advertising timeslot of the program stream based on a number of factors. For instance, the most appropriate advertisement will generally be the advertisement that is best targeted to the group of subscribers who are currently tuned to the SDV program in which the advertisement is to be inserted. Since the SDV manager 215 keeps track of the subscribers who are tuned to each SDV program, this information is available to the ad selection server 240 through the SDV manager 215. Thus, the ad selection server 240 can select an advertisement to be inserted into the programming stream based on the content of the program, knowledge of the subscribers currently watching the program, their demographic information, the particular advertisements that are available in the ad replacement server 230, or any combination of these factors. The advertisement that is determined to be most appropriate for the largest number of subscribers actively watching the program will hereinafter from time to time be referred to as the primary ad. The primary advertisement is inserted directly into the program stream by the ad replacement server 230.

By way of example, if a particular SDV program contains sports content and the single largest group of subscribers currently viewing the program are between the ages of 21 through 39 living in a household with annual incomes of less than $75,000 a year, the primary advertisement that is selected may be directed, for instance, to a low-cost beer.

As FIG. 2 indicates, in addition to the primary ad, the ad replacement server 230 may also send one or more alternative advertisements to the subscribers. The alternative advertisements are advertisements that can substitute or replace any given primary ad. In FIG. 2, the replacement server 230 shows three alternative advertisements. Similar to the primary ad, the alternative advertisements can be selected under the direction of the ad selection server 240. The determination as whether a primary advertisement should be replaced with one of the alternative advertisements may be made by the service provider through the SDV manager 215, for example, or by the individual set top terminals.

Continuing with the aforementioned example, if a particular subscriber viewing the SDV sports program is known to be over 70 years of age based on demographic information contained in the subscriber demographic database 250, the SDV manager 215 can instruct this subscriber's set top terminal to replace the primary advertisement for low cost beer with an alternative advertisement for a drug medication. Alternatively, the decision to replace the primary advertisement with the drug medication advertisement may be made by the subscriber's set top terminal itself and not by the SDV manager 215. The set top terminal could make this determination based on subscriber input that has been received through its user interface, in response, for instance, to a questionnaire or the like that is presented to the subscriber on a display.

The number of alternative advertisements that will be sent along with the primary advertisement can be determined based on the amount of network bandwidth that is available between the headend and the hub and/or between the hub and the set top terminal. For instance, if many different SDV programs are being viewed at any given time, excess bandwidth may be limited or nonexistent, in which case no alternative advertisements may be provided. On the other hand, as more bandwidth becomes available, the number of alternative advertisements that may be included can be increased, thereby providing more opportunities to selectively target a greater number of subscribers with customized advertising. The alternative advertisements can be sent in the same transport stream as the SDV program or in a separate transport stream dedicated to the alternative advertisements.

FIG. 3a illustrates an arrangement in which the headend 110 transmits a transport stream that includes the SDV program, the primary ad, and the alternative advertisements. FIG. 3b, on the other hands, shows an arrangement in which the headend 110 transmits a program stream that includes the SDV program and the primary ad. The alternative advertisements are transmitted in a separate transport stream or service. It should be noted that in some cases advertisements may be present in the SDV program when it is received by the headend 110. The ad replacement server 230 may or may not replace these ads with one of the primary or alternative advertisements. In addition, while the techniques described herein have been described in connection with SDV programs, they are also applicable to non-SDV (e.g. broadcast) programs, provided that the SDV manager 215 or other appropriate entity monitors the subscribers viewing the non-SDV programs.

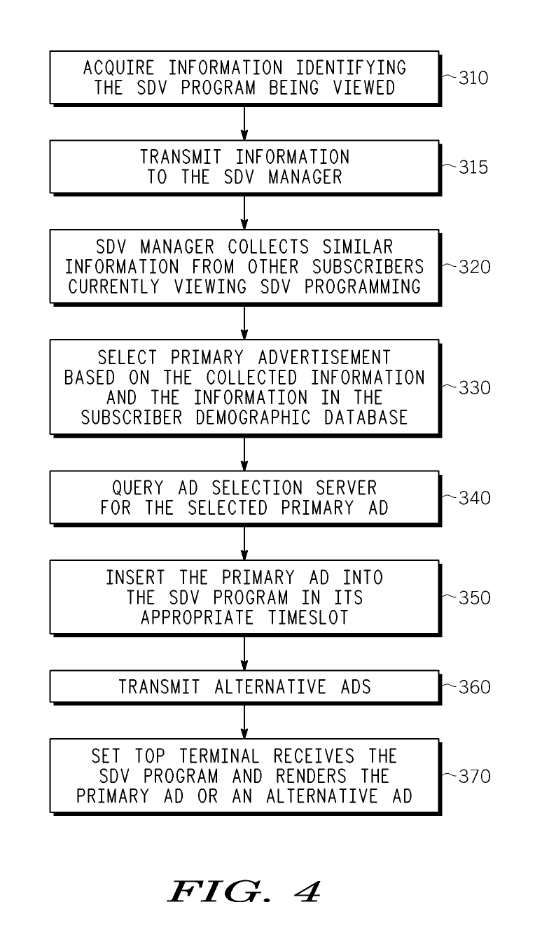

FIG. 4 is a flowchart that summarizes the aforementioned process by which an SDV program and alternative advertisements are provided to a subscriber. The process begins in step 310 when the SDV client in the set top terminal obtains current information concerning the SDV program being viewed. Such information may include, for example, the current SDV channel to which the set top terminal is tuned. The SDV client sends this information to the SDV manager in step 315. The SDV manager collects similar information from all the subscribers currently viewing this and other SDV programs in step 320. In step 330 the ad selection server uses this information from the SDV manager, along with the corresponding information in the subscriber demographics database, to select the primary advertisements for the SDV program. As the timeslots for the advertisements arrive, the ad replacement server will query the ad selection server in step 340 for the appropriate primary advertisement along with any alternative advertisements. The ad replacement server will insert the primary advertisement directly into the program stream in step 350, and bandwidth allowing, will transmit in step 360 the alternative advertisements, either in the program stream itself or in a separate transport stream. Finally, in step 370, the set top terminal receives the SDV program and either renders the primary advertisement or, under instructions from the SDV manager or rules implemented by the local SDV client in the set top terminal, replaces the primary advertisement with one of the alternative advertisements.

To further illustrate this process with a concrete example, assume a number of subscribers are currently watching a baseball game on a particular SDV channel. When a commercial break in the program arrives, the SDV manager 215 collects statistics concerning the viewers currently watching the program. The ad selection server 240 uses this information along with the information in the subscriber demographic database 250 to conclude that 50% of the current viewers should be targeted with an automobile ad, 15% should be targeted with a drug ad, 20% should be targeted with a beer advertisement and 15% should be targeted with an advertisement for children's products. Based on this information the ad selection server 240 will choose the automobile advertisement as the primary advertisement to be inserted into the SDV program by the ad replacement server 230. This way the majority of set top terminals will not need to perform a splicing process to replace the primary advertisement with an alternative ad. The SDV manager 215 also informs the ad selection server 204 that the available network bandwidth can support up to five alternative advertisements. Accordingly, the drug ad, beer advertisement and the children's product advertisement all may be sent to the set top terminals as alternative advertisements. When the individual set top terminals receive the advertisements they will either render the primary advertisement or one of the alternative advertisements based on instructions from the SDV manager 215 or based on pre-established rules that are implemented by the set top terminal itself. When the commercial break is over, the set top terminals will all return to rendering the baseball game. As subscribers tune in and out of the baseball game, the SDV manager 215 can dynamically update the demographics of the current viewers and in accordance therewith change the advertisements that serve as the primary and alternative ads.

The set top terminal can replace the primary advertisements with the alternative advertisements using any appropriate splicing technique. Since the programs and commercials are typically digitally encoded data streams (e.g., MPEG-2 data streams), the set top terminal should preferably be configured to support digitally encoded data stream splicing without converting the data stream to the analog domain. The set top terminal can implement any of a variety of different techniques for replacing the commercials which are known to those of ordinary skill in the art.

In the context of MPEG-2, a continuous video program is encoded in an elementary transport stream. The packets that make up the elementary stream can be recognized by their Packet Identifier (PID) value. The PID is a field located in the header of every transport stream packet. Thus, information pertaining to a single program can be selected by selecting those packets having the appropriate PIDs for the program's video, audio and/or data. Accordingly, at the appropriate time the SDV manager can instruct the set top terminal to replace a particular primary commercial by specifying both the PID of the primary commercial and the PID of the alternative ad. The SDV manager can send the PIDs in the same manner it sends other control information to the set top terminals using either in-band or out-of-band channels.

On the other hand, if the set top terminal itself makes the decision as to which alternative advertisement is to replace a primary ad, the SDV manager provides the set top terminal with the PIDs of the alternative advertisements as well as metadata that can be used to identify and characterize the advertisements. For instance, the metadata may include the ad's typical or intended demographic and psychographic groups. The set top terminal can use the metadata to match the subscriber's demographics, interests, and preferences with advertisements. For example, a shoe company may create three different advertisements to market their shoes: a first advertisement is directed at children, a second advertisement is directed at teenagers and young adults, and a third advertisement is directed at the middle-aged and elderly. One of these advertisements may be selected as the primary advertisement that is transmitted and the other advertisements may be transmitted as alternative advertisements. The set top terminal can use the metadata associated with each of the advertisements to select the commercial best suited for the subscriber based on the subscriber's demographic data or the type of advertisements requested by the subscriber.

The metadata can be sent either embedded in the advertisement or separate from it with the appropriate associating links. The metadata may be incorporated with the advertisements in any format that allows it to be recognized and extracted by the set top terminal. For example, the metadata may be incorporated into a program map table of an MPEG-2 bit stream. In another example, the metadata may be incorporated into the advertisement via standards established with the use of a metalanguage used to describe structured information. For example, the metalanguage that is employed may be a universal data format such as XML. In some cases the metadata may be conveniently located as an entry in one of the MPEG-2 system tables such as the PMT.

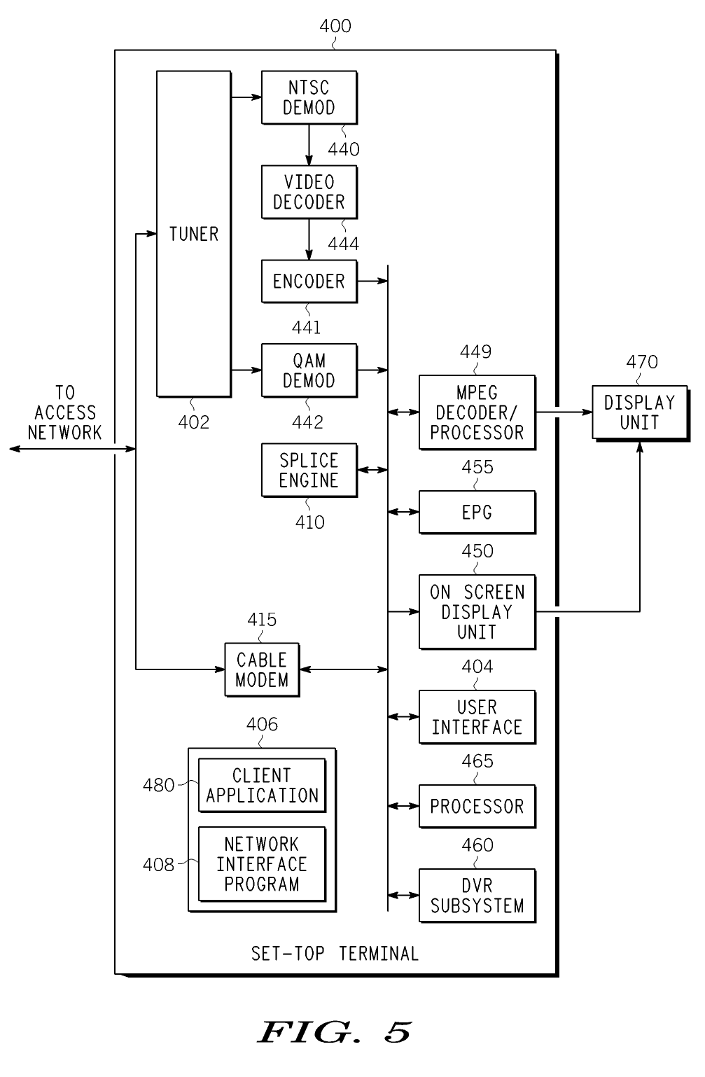

One example of a set top terminal 400 is shown in more detail in FIG. 5. It should be noted that set top terminal 400 more generally may be any apparatus such as a hardware card, specially programmed computer or other device having the functionality described herein that may be placed near to or within a television or other display device (such as a computer monitor) such as display unit 470. The set top terminal 400 receives content from cable access networks seen in FIG. 1. Broadly speaking, a traditional set top terminal such as that depicted in FIG. 5 is a device that can receive, store and forward content without manipulating the content in any significant way except to format it so that it may be rendered in a suitable manner.

Set-top terminal 400 includes an in-band tuner 402, which tunes to a channel signal selected by a consumer (not shown) via user interface 404. While not shown, a second in-band tuner may be provided, which could, for example, be used to receive the alternative advertisements when they are transmitted on a separate transport stream. User interface 404 may be any control device such as a remote control, mouse, microphone, keyboard, or display. NTSC demodulator 440 and digital demodulator 442 are responsive to in-band tuner 402. NTSC demodulator 440 includes components responsive to receive analog versions of a channel signal. A digital demodulator 442, which as shown is a QAM demodulator, but, which may be any type of digital demodulator device, includes components responsive to receive digital versions of a channel signal, and to output video information. QAM demodulator 442 receives and processes digital data packets from one or more digital sources, such as a digital television signal, an MPEG transport stream, or a media stream from an external network connection, such as cable modem 415 (if available), using well-known methods and techniques. Video decoder 444 is responsive to receive and decode video information.

Video information that may require format translation or modification for compatibility with capabilities of set top terminal 400 may be passed to encoder 441 for formatting. Video information that is in a format preferred for use by MPEG Decoder/Multi Media Processor 449 may be passed directly to MPEG Decoder/Multi Media Processor 449. Encoder 441 is operative to perform predetermined coding techniques (for example, MPEG-2, MPEG-4, and others) to produce an encoded video signal for transmission to MPEG Decoder/Multi Media Processor 449, or for storage. MPEG Decoder/Multi-Media Processor 449 is operative to perform predetermined coding techniques to arrange video information into displayable formats, in accordance with well-known methods and techniques. Internal arrangements of MPEG Decoder/Multi-Media Processor 449 are well known, and may include analog-to-digital converters, one or more storage media and/or buffers, and general or special-purpose processors or application-specific integrated circuits, along with demultiplexers for demultiplexing and/or synchronizing at least two transport streams (for example, video and audio).

Splice engine 410 implements any appropriate splicing process, such as those mentioned above, to replace the primary advertisement with a selected one of the alternative advertisements. If metadata associated with the advertisements is also provided, the metadata can be processed by the QAM demodulator 442, decoded by MPEG Decoder/Multi-Media Processor 449 and forwarded to processor 465.

An electronic program guide (EPG) 455 is also provided in set-top terminal 400. The EPG 455 is an interactive, on-screen display feature that displays information analogous to TV listings found in local newspapers or other print media. An EPG provides information about each program being broadcast within the time period covered by the EPG, which typically ranges from the next hour up to several days. The information contained in an EPG includes programming characteristics such as, for example, channel number, program title, start time, end time, elapsed time, time remaining, a brief description of the program's content and possibly the names of individuals associated with the program such as the actors, writers and director. The EPG, which is generally received along with the programming content, may be updated on a periodic basis so that the consumer can make appropriate selection for upcoming programs. For example, the electronic program guide 455 may display programs in a tabular format by channel and time so that the user can make selections of desired content. In some cases, instead of transmitting it along with the programming, the electronic program guide 455 may be downloaded via a telephone line, cable connection, satellite up-link, down-link, or radio broadcast antenna.

An on-screen display unit 450 is provided in set top terminal 400. The on-screen display unit 450 is used to display information such as control menus and the like as well as information received from the service provider or MSO that needs to be directly presented to the user regardless of the particular programming or channel that the user is currently viewing. In particular, on-screen display unit 450 displays the information provided by the EPG 455. Accordingly, on-screen display unit 450 can forward the information directly to the display unit 470, where it may appear as an overlay, pop up, or scrolling text ticker that is superimposed on the current programming being viewed. Alternatively, the information from the on-screen display unit 450 may even replace the current programming that appears on the display unit 470.

DVR subsystem 460 is provided for recording programs received from the access network. DVR subsystem 460 can control the channel tuned by tuner 402 and record programming on a manual or timer control basis. Additionally, the DVR subsystem 460 can buffer incoming programs to enable a view to pause or replay a portion of a live program.

Set-top terminal 400 further includes a computer-readable storage medium 406. Computer-readable storage medium 406 may be any local or remote device capable of recording or storing data, and in particular may be, or may include, a read only memory (“ROM”), flash memory, random access memory, a hard disk drive, all types of compact disks and digital videodisks, and/or magnetic tape. Various application programs may reside on storage medium 406. The applications residing on storage medium 406 may be computer programs that include software components implemented according to well-known software engineering practices for component-based software development and stored in computer-readable memories, such as storage medium 406. The applications, however, may be any signal processing methods and/or stored instructions, in one or more parts, that electronically control functions set forth herein. Storage medium 406 may also include other programs to provide additional functionality. For example, a network interface program 408 may be provided that represents aspects of the functional arrangement of various computer programs that pertain to the receipt and processing of content and other data over a broadband system.

The various components of set top terminal 400 discussed above may all operate under the overall control of a processor 465. Moreover, it is contemplated that the processor 465, tuner 402, video decoder 449, user interface 404, onscreen display unit 450, splice engine 410 and the other components shown in FIG. 5 may each be implemented in hardware, software or a combination thereof. In addition, although the various components are shown as separate processors, it is contemplated that they may be combined and implemented as separate processes on one or more processors.

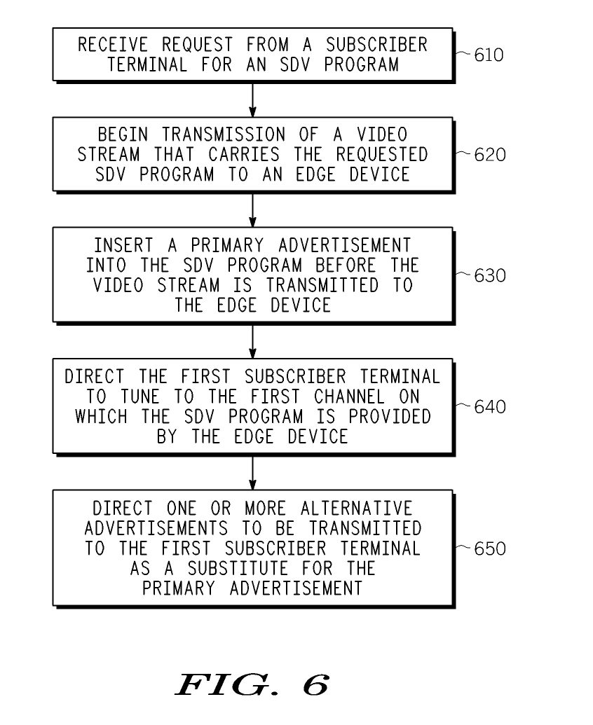

FIG. 6 is a flowchart illustrating one example by which an SDV program and alternative advertisements are provided to a subscriber. The method begins in step 610 when the SDV manager or other appropriate entity receives a request from a first subscriber terminal to receive an SDV program over an access network. In response to the request, the SDV manager instructs the content source in step 620 to begin transmission of a video stream that carries the requested SDV program to an edge device so that the edge device can deliver to the subscriber terminal a first channel on which the SDV program carried by the video stream is provided. In step 630, the ad selection server directs the ad replacement server to insert a primary advertisement into the SDV program before the section of the program containing the advertisement timeslot or window is transmitted to the edge device. The primary advertisement is selected at least in part on information relating to subscribers currently receiving the SDV program. In step 640 the SDV manager directs the first subscriber terminal to tune to the first channel on which the SDV program is provided by the edge device. The ad selection server, in step 650, directs one or more alternative advertisements to be transmitted to the first subscriber terminal as a substitute for the primary advertisement such that either the primary advertisement or the alternative advertisement is selectable for rendering by the first subscriber terminal.

The processes described above, including but not limited to those presented in connection with the headend and set-top terminal may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. At least one computer-readable medium encoded with instructions which, when executed by a processor, performs a method including:
receiving a request from a first subscriber terminal to receive an SDV program over an access network;
causing transmission of a video stream that carries the requested SDV program to an edge device such that the edge device delivers a first channel on which the SDV program carried by the video stream is provided;
directing the first subscriber terminal to tune to the first channel on which the SDV program is provided by the edge device;
causing a primary advertisement to be inserted into the SDV program before the video stream is transmitted to the edge device, wherein the primary advertisement is selected at least in part on information relating to subscribers currently receiving the SDV program; and
directing at least one alternative advertisement to be transmitted to the first subscriber terminal as a substitute for the primary advertisement such that either the primary advertisement or the alternative advertisement is selectable for rendering by the first subscriber terminal.

2. The computer-readable medium of claim 1 further comprising selecting the primary advertisement at least in part on the information relating to subscribers currently receiving the SDV program and also on information relating to the content of the SDV program.

3. The computer-readable medium of claim 1 further comprising transmitting a signal over the access network directing the first subscriber terminal to substitute the alternative advertisement for the primary advertisement.

4. The computer-readable medium of claim 1 wherein the video stream is an MPEG stream and the first subscriber terminal is provided with a Packet Identifier (PID) for the alternative advertisement in order to substitute the alternative advertisement for the primary advertisement.

5. The computer-readable medium of claim 1 further comprising directing metadata associated with the alternative advertisement to be transmitted to the first subscriber terminal, wherein the metadata is sufficient to allow characterization of the alternative advertisement for purposes of determining its target audience.

6. The computer-readable medium of claim 1 further comprising monitoring available network bandwidth to determine a maximum number of alternative advertisements that are to be transmitted as a substitute for the primary advertisement.

7. The computer-readable medium of claim 1 wherein the alternative advertisement is transmitted in the video stream that carries the requested SDV program.

8. The computer-readable medium of claim 1 wherein the alternative advertisement is transmitted in a video stream distinct from the video stream that carries the requested SDV program.

9. The computer-readable medium of claim 1 wherein the information relating to the subscribers currently receiving the SDV program includes demographic information.

10. The computer-readable medium of claim 1 further comprising selecting the primary advertisement and the alternative advertisement based on statistical demographic information concerning the subscribers currently receiving the SDV program.

11. The computer-readable medium of claim 1 wherein the primary advertisement is selected from among a plurality of candidate alternative advertisements each having a target audience matching a percentage of the subscribers currently receiving the SDV program, and wherein the primary advertisement has a target audience matching a highest percentage of the subscribers currently receiving the SDV program.

12. At least one computer-readable medium encoded with instructions which, when executed by a processor, performs a method including:
collecting information concerning current network resource availability and subscribers currently viewing SDV programming using network resources;
for each SDV program currently being viewed by a subscriber, selecting a primary advertisement to be inserted into an advertising timeslot of a video transport stream in which the SDV program is embodied, wherein the selection is based at least in part on the collected information;
for each of the SDV programs currently being viewed by a subscriber, selecting a plurality of alternative advertisements to selectively replace the primary advertisement, wherein the selection of the plurality of alternative advertisements is based at least in part on the collected information; and
transmitting each of the video transport streams and the plurality of alternative advertisements associated therewith to the subscribers viewing the respective SDV programs.

13. The computer-readable medium of claim 1 further comprising increasing or decreasing the number of alternative advertisements that are selected as current network resource availability respectively increases or decreases.

14. A set top terminal comprising:
a receiver/tuner for receiving (i) SDV programs over a broadband access network, at least one of the SDV programs including a primary advertisement and (ii) a plurality of alternative advertisements that are each substitutable for the primary advertisement;
a processor operationally associated with the receiver/tuner; and
wherein the processor is configured to selectively cause a first of the alternative advertisements to be rendered instead of the primary advertisement when the first alternative advertisement better matches a prescribed condition than the primary advertisement.

15. The set top terminal of claim 14 wherein the prescribed condition indicates that the first alternative advertisement is better demographically targeted to a subscriber viewing one of the received SDV programs than the primary advertisement.

16. The set top terminal of claim 14 wherein the processor causes the first alternative advertisement to be rendered in response to receipt of a signal over the access network.

17. The set top terminal of claim 16 wherein the SDV programs are received in MPEG transport streams and the signal includes a Packet Identifier (PID) for the alternative advertisement, which PID is used by the processor to substitute the alternative advertisement for the primary advertisement.

18. The set top terminal of claim 14 wherein the processor causes the first alternative advertisement to be rendered by using metadata to determine if the prescribed condition is met.

19. The set top terminal of claim 18 wherein the metadata is sufficient to allow characterization of the alternative advertisement for purposes of determining its target audience.

20. The set top terminal of claim 14 wherein the prescribed condition is user-definable.

21. At least one computer-readable medium encoded with instructions which, when executed by a processor, performs a method including:
receiving over a broadband access network an SDV program that includes a primary advertisement and a plurality of alternative advertisements that are each substitutable for the primary advertisement; and
rendering a first of the alternative advertisements instead of the primary advertisement when the first alternative advertisement better matches a prescribed condition than the primary advertisement.

22. The computer-readable medium of claim 21 wherein the prescribed condition indicates that the first alternative advertisement is better demographically targeted to a subscriber viewing one of the received SDV programs than the primary advertisement.

23. The computer-readable medium of claim 21 wherein the first alternative advertisement is rendered in response to receipt of a signal over the access network.

24. The computer-readable medium of claim 23 wherein the SDV program is received in MPEG transport stream and the signal includes a Packet Identifier (PID) for the alternative advertisement and further comprising substituting the alternative advertisement for the primary advertisement using the PID.

25. The computer-readable medium of claim 21 wherein the prescribed condition is user-definable.
